(19) United States
(12) Patent Application Publication
(10) Pub. No.: US 2019/0249543 A1
(43) Pub. Date: Aug. 15, 2019

(54) RECONFIGURABLE TOOL BUS NETWORK FOR A BOTTOM HOLE ASSEMBLY

(71) Applicant: Jianying Chu, Houston, TX (US)

(72) Inventor: Jianying Chu, Houston, TX (US)

(21) Appl. No.: 15/893,225

(22) Filed: Feb. 9, 2018

(51) Int. Cl. E21B 47/12; G05B 23/02; E21B 47/00; H02H 1/00; H02H 3/10

(52) U.S. Cl. CPC E21B 47/12; G05B 23/0208; E21B 47/00; E21B 17/003; H02H 1/0007; H02H 3/105; G05B 2219/25004; H02H 1/0092

(57) ABSTRACT

A reconfigurable network for interconnecting tools in a bottom hole assembly is disclosed. The network includes nodes that have reconfigurable switches that can be configured to provide a conductive path for the bus through the node, connect a terminator to the bus, and/or connect a tool to the bus. The exact configuration (i.e., states) of the switches in each node may be automatically selected based on a detected fault in a tool attached to a node and/or the state of other switches in the node or/a specific request is received. Various node embodiments and a method and circuit for automatically disconnecting a tool from the network in response to a tool fault are further disclosed.

### FIELD OF THE INVENTION

The present disclosure relates to a communication network for use in a wellbore and more specifically, to tool bus network for a bottom hole assembly (BHA) that can reconfigure itself automatically (e.g., based on the detection of a fault or by the control from an application request).

### BACKGROUND

Electronics are increasingly desired for testing, measurement, control, actuation, and communication in downhole (i.e., in a wellbore) applications, such as measurement while drilling/logging while drilling (MWD/LWD) and directional drilling (or geosteering), wireline logging, coil tubing, slickline services, and the like.

Downhole environments are harsh. Accordingly, electronics in a downhole environment may experience high pressures, conductive fluids, corrosive chemicals, severe vibrations, and mechanical shocks that are in excess of their designed specifications. As a result, protective packages typically house the electronics to insure reliable operation.

A BHA typically includes a plurality of these protective packages (i.e., segments) connected end-to-end at segment joints. Each segment encloses electronics to protect them from the harsh environments and operating conditions. Typically, the segments are constructed from high-strength metal or metal alloys and have a tubular form to allow the BHA to be easily moved through a borehole regardless of the trajectory of the borehole.

Adjacent segments can be electrically connected to form a network allowing the electronics in each segment to share data and electrical power. Accordingly, the electronics inside the segments may be networked to communicate with each other. Due to geometrical and structural constraints of the segment joints, however, the possible network topologies are limited.

Owing to its simplicity and reliability, one popular network topology used for downhole communication is a bus network. The bus network includes a common electrical path, or paths (i.e., a bus) passing through each segment, connecting the segments, and terminated at each end.

Tools are electronic devices that operate to perform a particular function (e.g., formation measurement and evaluation, drillstring monitoring and geosteering, etc.). The tools may tap into the bus (i.e., tool bus) as communicating nodes to exchange data/power. A group of tools exchanging power and data via a bus are referred to collectively as a tool bus network (i.e., toolstring). The simplicity of the tool bus network unfortunately also makes it prone to failure.

The tool bus network described thus far can be disabled if any part of the bus fails (i.e., single point of failure). Troubleshooting the point (or points) of failure in a disabled tool bus network is difficult because communication over a failed tool bus network is impaired or disabled. As a result, in situ (i.e., while downhole) and/or on the fly (i.e., during a downhole process) troubleshooting methods may be unavailable, and instead, the BHA must typically be extracted from the well bore for troubleshooting. Adding to the problem, the electronics in the extracted segments are not easily tested (i.e., probed) because they are typically sealed within pressurized chambers. In these cases, the BHA must also be dismantled piece-by-piece to troubleshoot the failure. To make matters worse, the extraction of the BHA does not guarantee successful trouble shooting for a few reasons.

First, the act of extracting the BHA may change or obscure the point (or points) of failure. Second, it may be impossible to emulate downhole conditions at the surface. As result, it can be very difficult to replicate a failure caused by a downhole condition while the BHA is at the surface. Third, experienced trouble-shooters may not be available at a drill rig site. In these cases, a failed toolstring must be shipped back to a nearby repair and maintenance (i.e., R&M) location or technology center for troubleshooting.

A failure (i.e., fault) in a tool bus network can be disruptive, costly, and can lead to unwelcomed outcomes. For example, the time spent troubleshooting is non-productive time (NPT) for the downhole application. Accordingly, a lengthy repair process and its excessive cost can lead to a negative customer response. In addition, the adoption and/or validation of new tools can be significantly hindered by the time/cost of such failures.

The tool bus network described thus far has additional limitations. The tool bus network is limited in its convenience and immunity to human error. For signal integrity, the tool bus network requires a proper termination at each endpoint of the bus to prevent reflections. Because each job for a drill rig may have different requirements, tools in a tool bus network are assembled into a particular configuration for each job (i.e., on an ad hoc basis). As a result, an added procedure of setting up terminations at the bus endpoints, according to a particular configuration, is required. In other words, permanently installing terminators in a tool bus network is not feasible.

Efforts have been made to overcome some of the limitations of the bus network described above. For example, to address bus failures, U.S. Patent Publications 2017/0002640 and 2017/0059637 disclose sensing bus currents for an over current event. If an over current event is sensed, switches are used disable a portion of the toolstring so that a different portion of the toolstring can still operate. In both disclosures, the over current events result from short circuits. Short circuits, however, are only one mode of failure (i.e., fault) that the toolstring may experience. The disclosures fail to address open-circuit failures and other faults, such as an intermittent bus connection, loss of a bus terminator, an erratic node response, and the like. In addition, neither disclosure teaches how to pinpoint the cause of the failure. In order to troubleshoot the failure effectively, a comprehensive failure snapshot, which locates the failure site and identifies the root cause of failure, is highly desirable.

A need, therefore, exists for a reconfigurable network for tools in a downhole BHA that can address the limitations described above by automatically identifying/diagnosing faults, and in response, automatically reconfiguring the network (e.g., by adding/removing a tool or by adding/removing a terminator) to isolate the faults and minimize the consequences.

### SUMMARY

Accordingly, in one aspect, the present disclosure embraces a reconfigurable tool bus network for a BHA. The network includes a bus for communicating power and data between nodes in the BHA, which are electrically connected to and distributed along the bus. Each node includes a tool switch (SD) that can be configured to connect or disconnect the tool (i.e., more specifically, the tool electronics after the tool switch) from the bus. Each node also includes a main controller block that is communicatively coupled to the bus and is used to control the node's connections (e.g., the tool switch). The main controller block typically includes (but is not limited to) a main controller, a clock, a memory, varied interfaces, and other tool functional circuits. The main controller may be embodied as a digital signal processor (DSP), a microcontroller, an FPGA, an ASIC or a special integrated circuit (IC) and can detach the tool from the bus when a fault in the tool is detected. To accomplish this, the processor repeatedly performs a diagnostic test on the tool to check for a fault. The main controller generates output signals that correspond to the results (i.e., fault found, no fault found) of each diagnostic check. The state of the tool switch (i.e., open or closed) is based on the output signal so that when the tool fails a diagnostic check (i.e., has a fault) the tool switch is opened and the tool is disconnected from the bus (i.e., the network).

In an exemplary embodiment of the network, The BHA is comprised of segments that are mechanically coupled end-to-end at joints, and the bus is electrically connected at each joint to span the segments. In some embodiments the bus includes a single channel for power and data, while in others the bus includes separate channels for power and data.

In another exemplary embodiment of the network, each node also includes a first bus switch (SA) and a second bus switch (SB) that are connected in series with the bus (and with each other). The bus switches (SA, SB) are controlled by the main controller block to connect or disconnect a first portion of the bus to a second portion of the bus. Thereby, a tool bus is divided into multiple sections by the connected nodes. All sections can be independently controlled for varied operation purpose (e.g., as part of a trouble shooting operation or in response to a bus fault).

In another exemplary embodiment of the network, each node also includes a terminator switch (SC) that can be configured to connect or disconnect a terminator to the bus based on the states (i.e., open/open, open/closed, closed/open, closed/closed) of the bus switches (SA, SB). In particular, whenever the first bus switch (SA) or the second bus switch (SB) in the node at an endpoint of the bus is open, then the terminator switch (SC) is closed to connect the terminator to the bus. The switches (i.e., SA, SB, and SC, SD) may be bidirectional or unidirectional switches and each may be a metal oxide semiconductor field effect transistor (i.e., MOSFET) switch.

In another exemplary embodiment of the network, at least one of the nodes communicatively couples the network for the BHA to equipment at a surface of a wellbore using telemetry.

In another exemplary embodiment of the network the main controller is used to disconnect (i.e., detach) the tool from the bus (i.e., by opening the tool switch (SD)) when a request to disconnect the tool is received from the bus.

In another exemplary embodiment of the network, the signals output from the main controller that correspond to the result of each diagnostic check comprise a voltage pulse train while no tool fault is detected and a DC voltage while tool fault is detected. The signals can be fed to the input of a secured control line (SCL) circuit to achieve a secured control over the switches (i.e., SA, SB and SD) in the event of a tool fault or a power loss. For example, while the voltage pulse train is input to the SCL circuit, the SCL circuit outputs a first voltage (e.g., a logical low), which controls the tool switch (SD) to connect (i.e., attach) the tool to the bus (i.e., close tool switch (SD)). Alternatively, while the DC voltage is input to the SCL circuit, the SCL circuit outputs a second voltage (e.g., a logical high), which controls the tool switch (SD) to disconnect the tool from the bus (i.e., open tool switch (SD)).

In another aspect, the present disclosure embraces a node for a tool bus network for a BHA. The node includes a tool switch (SD) that can be configured to connect or disconnect a tool from the bus. The node also includes a main controller block that is communicatively coupled to the bus and is used to control the tool switch. The main controller block can detach the tool from the bus when a fault in the tool is detected. To accomplish this, the main controller in the block repeatedly performs a diagnostic test on the tool to check for a fault. The main controller outputs a signal that correspond to the results (i.e., fault found, no fault found) of each diagnostic check. The state of the tool switch (i.e., open or closed) is based on the output signal so that when the tool fails a diagnostic check (i.e., has a fault) the tool switch is opened and the tool is disconnected from the bus (i.e., the network).

In various embodiments the node may be configured or operated as described above in embodiments of the network.

In another aspect, the present disclosure embraces a method for automatically disconnecting a tool from a network for a bottom hole assembly (BHA) when a fault is detected. In the method a tool is tested repeatedly for a fault. For each test that does not detect a fault a voltage pulse is generated. In other words, a pulse train is generated as the tool repeatedly passes each test. The pulse train is then transformed into a logic level (i.e., logical low) that closes (or keeps closed) the tool switch, thereby connecting the tool to the network. When a fault is detected, a DC voltage is generated. The DC voltage is then transformed into a logic level (i.e., logical high) that opens (or keeps open) the tool switch, thereby disconnecting the tool from the network.

In another aspect, the present disclosure embraces a node for a tool bus network for a BHA. The node includes a first bus switch configurable based on a first control signal to connect a first bus section to a second bus section so that when the bus switch is closed data and/or power is able to pass between the first and second bus sections. The node also includes a tool switch configurable based on a second control signal to connect tool electronics within the node to the second bus section when the tool switch is closed. The node also includes a main controller of the tool electronics connected to the tool switch, wherein the main controller is configured to generate the first control signal and the second control signal with a secured control line circuit to control the bus switch to disconnect the first and second bus sections and/or control the tool switch to disconnect the tool electronics from the second bus section when a fault is detected.

In various aspects of the node, the first and second bus sections comprises separate electrical channels for the data and power.

In any of the above aspects of the node, the bus switch comprises a unidirectional switch, a combination of two unidirectional switches in a back-to-back or head-to-head configuration, or a bidirectional switch.

In any of the above aspects of the node, the main controller of the tool electronics is configured to generate the second control signal with the secured control line circuit to issue a default state to open the tool switch to disconnect the tool electronics from the second bus section or to issue a secured state to close the tool switch to connect the tool electronics to the second bus section. In some implementations, the secured control line circuit comprises an AC-coupled rectification circuit configured to issue the secured state in response to receiving a pulse train and otherwise issue the default state. In some implementations, the main controller is configured to run a self-diagnostic test to test for a fault in the tool electronics, wherein the main controller is configured to provide the pulse train to the AC-coupled rectification circuit when the fault is not detected. In some implementations, the AC-coupled rectification circuit is configured to pass an AC component of the pulse train to a rectification circuit to generate a voltage level corresponding to a secured-high state. The AC-coupled rectification circuit is further configured to block DC signals from being passed to the rectification circuit to generate the default state. In some implementations, the secured control line circuit further comprises a voltage inversion circuit connected to an output of the rectification circuit, wherein the inversion circuit is configured to generate a voltage level corresponding a secured-low state upon receiving the voltage level corresponding to the secured-high state.

In any of the above aspects of the node, the node further comprises a terminator switch configurable to connect a terminator to the second bus section when the terminator switch is closed, wherein the terminator switch is configurable based on the bus switch. In some implementations, the terminator switch is open when the bus switch is closed. In some implementations, the terminator has a same characteristic impedance as the second bus section.

In any of the above aspects of the node, the node further comprises a second bus switch configurable based on a third control signal to connect the second bus section to a third bus section so that when both the first bus switch and the second bus switch are closed, data and/or power is able to pass between the first, second, and third bus sections.

In any of the above aspects of the node, the node further comprises a first delay circuit with an input connected to the second bus section and configured to change an output of the first delay circuit after a first defined delay according to a change in a voltage level on the second bus section. In some implementations, the node further comprises a second delay circuit with an input connected to the second bus section or the output of the first delay circuit and configured to change an output of the second delay circuit after a second defined delay according to a change in a voltage level on the second bus section or a change in the output of the first delay circuit. In some implementations, the second defined delay is longer than the first defined delay when the input of the second delay circuit is connected to the input of the first delay circuit to create a window to control the tool switch to disconnect the tool electronics from the second bus section when a fault is detected. In some implementations, the first bus switch is configured to close to connect the first bus section to the second bus section after the second defined delay if a fault is detected in the tool electronics.

In any of the above aspects of the node, the node further comprises a current limiter in series with the tool switch configured to limit an amount of current which can pass to the tool electronics.

According to the various aspects of the node above, the node is part of a bus comprised of bus sections that are connected at a plurality of such nodes to form a tool bus network for a bottom hole assembly (BHA).

The foregoing illustrative summary, as well as other exemplary objectives and/or advantages of the disclosure, and the manner in which the same are accomplished, are further explained within the following detailed description and its accompanying drawings.

Other systems, methods, features and/or advantages will be or may become apparent to one with skill in the art upon examination of the following drawings and detailed description. It is intended that all such additional systems, methods, features and/or advantages be included within the scope of this description.

### BRIEF DESCRIPTION OF THE DRAWINGS

FIG. 1 is a schematic diagram of a conventional tool bus network according to current industry practice.

FIG. 2 is a schematic diagram of a reconfigurable tool bus network for a BHA in accordance with an exemplary embodiment of the present disclosure.

FIG. 3 is a schematic diagram of a node for a reconfigurable tool bus network for a BHA according to an exemplary embodiment of the present disclosure.

FIG. 4 is a schematic diagram of a node for a reconfigurable tool bus network for a BHA according to another exemplary embodiment of the present disclosure.

FIG. 5 are schematics of switches that may be used in a node for a reconfigurable tool bus network for a BHA according to various exemplary embodiments of the present disclosure.

FIG. 6 is a schematic diagram of a node for a reconfigurable tool bus network for a BHA according to another exemplary embodiment of the present disclosure.

FIG. 7 is a schematic diagram of a node for a reconfigurable tool bus network for a BHA according to another exemplary embodiment of the present disclosure.

FIG. 8 is a flow chart illustrating a method for detecting faults and reconfiguring a tool bus network for a BHA according to an exemplary embodiment of the present disclosure.

FIG. 9 is a schematic diagram of a secured control line circuit for a reconfigurable tool bus network for a BHA according to an exemplary embodiment of the present disclosure.

### DETAILED DESCRIPTION

Some terminology used in the present disclosure may be typically defined as follows. A “tool” is a functional unit which may include electronics, sensors, and other components to execute particular functions. A tool may contain “tool electronics” that perform the function of the functional unit. A “toolstring” (i.e., tool bus network) is a group of tools connected to a common tool bus for the exchange of data and power. A “segment” is a structural unit, which has sealed cavities to accommodate electronic, and which typically has a tubular form. A “bottom hole assembly” (BHA) is a group of segments that are connected end to end that that have tools installed inside. A tool may be contained within one segment, multiple segments (e.g., adjacent segments, interleaved segments), or may share a segment with one or more other tools. A “tool bus” (i.e., bus) is a common communication channel over which data and power can be exchanged, that is terminated at each distal end (i.e., endpoint). A “node” is alternate terminology for the functional unit. A node has only one access point to the tool bus, while a tool may have none, one, or multiple access points to the tool bus. Depending on the complexity of a tool, a tool may consist of one or multiple nodes. Additionally, multiple tools maybe integrated into one node. For simplicity, in what follows, a tool is assumed to consist of only one node and therefore the term “tool” may be used interchangeably with “node.” This configuration is not intended to be limiting to the scope of the disclosure because, as mentioned above, the tool/node configuration may vary in practice. Additionally, the term “tool” is further used to specifically refer to the node backend electronics after the tool switch. However, it should be understood that this use does not imply any limitations of the principles and methods disclosed herein because tools may be embodied variously.

### Conventional Tool Bus Network

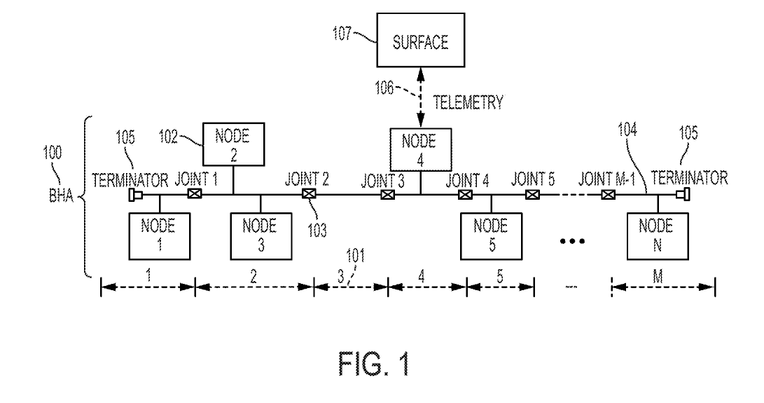

FIG. 1 is a schematic diagram of a conventional tool bus network for a BHA in accordance with current industry practice. A downhole BHA 100 consists of M segments 101 that are connected end-to-end at M−1 joints 103.

A tool bus 104 spans these joints and extends to two distal endpoints at which terminators 105 are installed to prevent reflections. The tool bus 104 has N nodes 102 distributed along the M segments 101. N and M are integral numbers. For example, N is typically in the range of 2 to 16 and M is typically in the range of 2 to 8.

It is typical for at least one node 102 to communicate with the surface 107 through the telemetry 106. For example, as shown in FIG. 1, Node 4 communicates to equipment located at the surface of a wellbore (i.e., surface 107) using telemetry 106. The telemetry 106 is a point-to-point communication for real-time data and/or power transmission between the downhole BHA 100 and the surface 107. Various types of telemetry 106 may be used for this purpose. For example, the telemetry may be mud pulse, wired-pipe, continuous cable, electromagnetic (EM) wave, acoustic wave, or a combination thereof. As shown in FIG. 1, Node 4 functions as the interface between the tool bus 104 and the telemetry 106. Accordingly, this node performs all necessary protocol translation and power conversion between the two systems.

As shown in the FIG. 1, all nodes 102 are connected to one common path (i.e., the bus), which makes the network vulnerable to failure at any point along the bus. A failure can manifest as short circuit or open circuit and may arise within any connected node 102 or anywhere along the bus.

A short circuit may disable the network and can be characterized as alternating current (AC) short circuit or direct current (DC) short circuit. AC short circuits may occur at a signal transmitter within a node and can make driving the bus impossible. DC short circuits may occur anywhere and can result in a high current drawn from the bus power source.

An open circuit may also disable the network. An open circuit in a bus section 103 may impair communication because the open circuit causes signal reflections and because the terminator is effectively removed from the bus by the open circuit. An open circuit within a node 102 may only affect the node itself. The limiting of the affect is somewhat desirable for operation because the problematic node is effectively quarantined from the bus (i.e., by the open circuit).

Of all the failures, a failure at a joint 103 between segments can be most the most difficult to troubleshoot. For example, difficulty in troubleshooting may arise when the BHA is removed from the wellbore because the failure may “disappear” as the environment is changed. Accordingly, it is desirable to characterize these failures on the fly because downhole conditions are difficult to duplicate at the surface.

### Reconfigurable Tool Bus Network

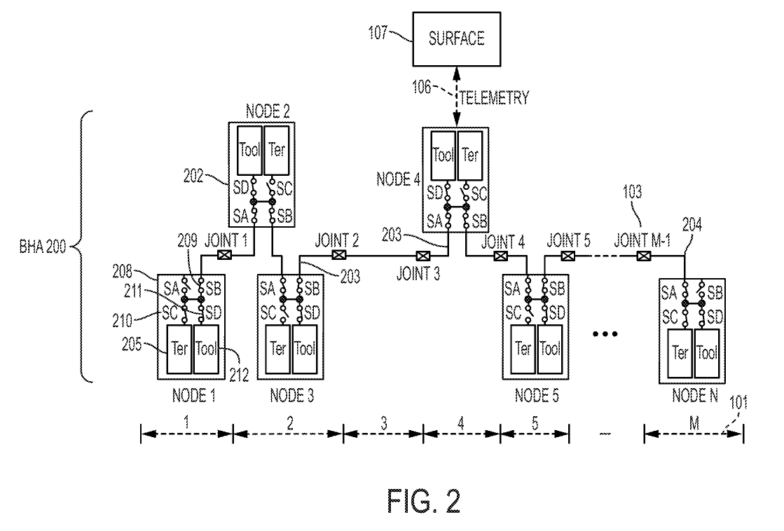

FIG. 2 is a schematic diagram of a reconfigurable tool bus network in accordance with an exemplary embodiment of the present disclosure. For ease in illustrating the principles and methods of the present disclosure, FIG. 2 illustrates an embodiment in which both power (i.e., bus power, power signal, etc.) and data (i.e., bus data, data signal, etc.) are transmitted together on a common electrical path (i.e., bus). It should be understood that the principles and methods disclosed herein might be used for embodiments in which power and data are transmitted separately through two (or multiple) common electrical paths.

As in the conventional embodiment described previously (FIG. 1), a BHA 200 consists of M segments 101 connected in end-to-end and N nodes 202 distributed along the M segments. A tool bus (i.e., bus) 204 includes N−1 sections 203 that are joined together through the N nodes 202. Each section 203 is a bus channel between two adjacent nodes 202.

Unlike the conventional embodiment described previously, each node 202 includes switches that allow the network to be configured (or reconfigured) without removing the BHA 200 from downhole (e.g., during a wellbore process). The tool bus network is intelligent and versatile because each section 203 and each node 202 of the bus 204 can be controlled independently or in sequence to achieve varied functions. For example, nodes 202 and sections 203 can be powered on in sequence to identify the site or the nature of a fault. The bus 204 is reliable because the nodes 202 can monitor and detect bus conditions and configure their switches accordingly to maintain communication over the bus 204 in the presence of a fault.

Each node 202 in the intelligent tool bus network includes a first bus switch (SA) 208 and a second bus switch (SB) 209 that are connected in series and that are each electronically configurable in an open/closed position. The bus switches 208 and 209 are arranged in series with the bus sections 203 and with each other. The state of the switches 208 and 209 therefore determines the transmission of signals through the node and along the bus. For example, bus signals may pass through the node when both SA 208 and SB 209 are in a closed position.

Each node 202 also includes a terminator switch (SC) 210 electrically connected to a point between SA 208 and SB 209 and a terminator 205 (e.g., contained in the node). The terminator switch 210 in a node can be used to terminate the bus 204 by closing SC 210. For example, if SA 208 is closed and SB 209 is open then SC 210 is closed to prevent reflections on the bus 204 that would otherwise be caused by the opened SB 209.

Each node 202 also includes a tool switch (SD) 211 electrically connected to a point between SA 208 and SB 209 and tool 212. The tool switch 211 attaches/detaches the tool 212 to/from the bus 204 when it is closed/open.

The state of the four switches (i.e., SA, SB, SC, and SD) in each node 202 can be based on rules. For example, the SC 210 closes if one of the bus switches SA 208 and SB 209 are open to have the bus 204 always properly terminated. As shown in FIG. 2, Node 1 and Node N are located at the two endpoints of the bus 204. Accordingly, each endpoint node has one closed bus switch (i.e., SB 209 in the Node 1 and SA 208 in the Node N, respectively) and a closed terminator switch. To detach Node 1 from the bus and make Node 2 the endpoint, SA 208 of Node 2 is opened. The opening of SA 208 causes the terminator switch SC 210 of Node 2 to close, thereby terminating the bus 204 automatically.

A tool switch SD 211 of a node 202 is open/closed to attach/detach one (or more) tool 212 to the bus 204. A tool 212 may be attached to the bus 204 (i.e., SD closed) if the node 202 is located at an endpoint of the bus (i.e., SA or SB open) or if the node 202 is located along the bus (i.e., SA and SB closed). As shown in FIG. 2, intermediate nodes 2 to N−1 each have closed switches SA, SB, and SD so that the node 202 passes bus signals and so that a tool 212 connected to the node is attached to the bus. The intermediate nodes 2 to N−1 each have opened terminator switches 210 to avoid terminating the bus at an intermediate point.

One or more nodes 202 may be selected to communicate with the surface 107 via their own telemetry 106. As shown in FIG. 2, Node 4 is selected to communicate to the surface 107 via telemetry 106. This selection may be dynamic. Accordingly, if the intelligent tool bus network is reconfigured, different nodes 202 may be selected to communicate with the surface 107.

### First Node Embodiment—Bus with Combined Data and Power

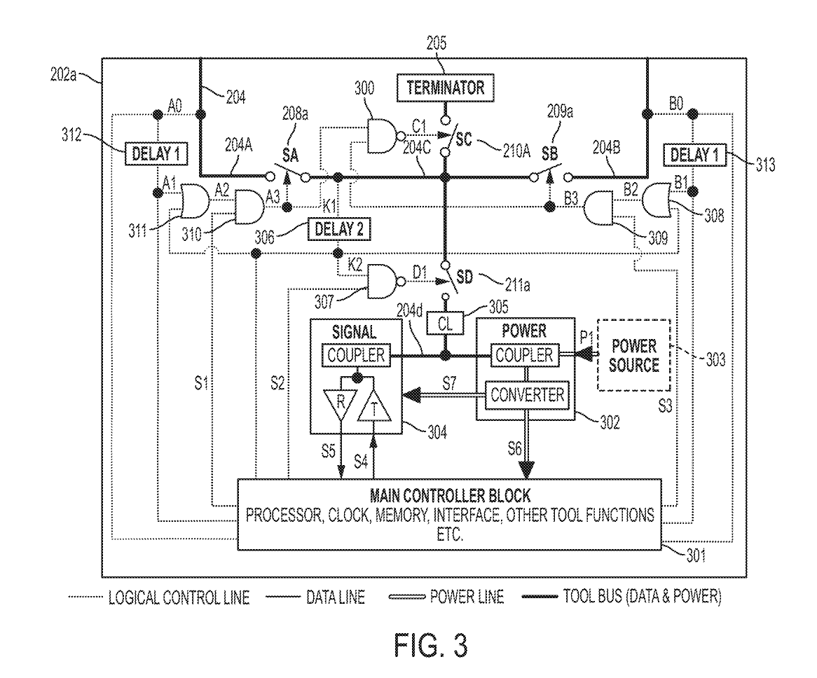

FIG. 3 is a schematic diagram of a first exemplary embodiment of a node 202 for the intelligent tool bus network. In the FIG. 3, the tool bus 204 inside the node is divided into three sections 204A, 204B, 204C by two bus switches SA 208a and SB 209a. Section 204A is between a first side of the bus switch SA 208a and a first adjacent node. Section 204B is between a second side of the bus switch SA 208a and a first side of the bus switch SB 209a. Section 204C is between a second side of the bus switch SB 209a and a second adjacent node. The terminator switch SC 210a is used to connect or disconnect the terminator 205 from the section 204C. The tool switch SD 211a is used to connect or disconnect tool electronics from the section 204C. A current limiter CL 305 is in series with the tool switch SD 211a and is used to limit the current, which passes through the tool switch SD 211a. The section 204D is derived from the CL 305 and connected to the signal block 304 and the power block 302.

The signal block 304 is coupled to the section 204D through an internal signal coupler. In receiving mode, the data signal is extracted by the internal receiver and forwarded to the main controller block 301 through the signal line S5. In transmitting mode, the data is received from the main controller block 301 through the signal line S4 and put on the section 204D by the internal transmitter via the signal coupler. The transmitter of the signal block 304 should appear to be high impedance when not in transmitting mode. Otherwise, it can disrupt the transmitter of other nodes from operating properly. The AC short-circuit failure occurs if the transmitter appears to be low impedance when not in transmitting mode. In the event of AC short circuit, the signal block 304 should be disconnected from the bus 204.

The power block 302 is coupled to the section 204D through one power coupler. The power block 302 may also receive the electrical power from the power source 303 via a powering line P1. The power source 303 typically derives from lithium batteries, downhole alternator, power supply or their combination. The power source 303 can be used to power the other nodes or exclusively itself. Usually, the power block 302 has the internal converter to regulate the received power into the voltage levels suitable for its local needs, such as the powering line S7 to the signal block 304 and powering line S6 to the main controller block 301.

Herein, a coupler (power or signal) is defined to pass through signals of interest at a minimal insertion loss while blocking other signals at minimal loading effect (i.e. with a high apparent input impedance to other signals). A coupler differs from a filter in that the filter emphasizes the output characteristics instead of the input characteristics so that a filter may has a low apparent input impedance to other signals. Bus power in the downhole BHA 200 is typically DC. In case of AC power used, it must use a frequency band different from that of bus signal.

The four switches of SA 208a, SB 209a, SC 210a and SD 211a close when the logical control line A3, B3, C1 and D1 is logically true (or physically high), respectively. The line A3 is the logical AND 310 of the line A2 and the line S1. That is, the line A3 is true only if both the line A2 and the line S1 are true. The line A2 is the logical OR 311 of the line A1 and the line K2. That is, the line A2 is true if any of the line A1 and the line K2 are true. The line A1 turns true in the Delay1 312 after the line A0 turns true. The line A0 turns true once the voltage of the section 204A goes into the defined or expected range, which is typically the voltage range of operating DC power. Similarly, the line K2 turns true in the Delay2 306 after the line K1 turns true. The line K1 turns true once the voltage of the section 204C goes into the defined or expected range. The line B3 is the logical AND 309 of the line B2 and the line S3. That is, the line B3 is true only if both the line B2 and the line S3 are true. The line B2 is the logical OR 308 of the line B1 and the line K2. That is, the line B2 is true if both or either of the line B1 and the line K2 are true. The line B1 turns true in the Delay1 313 after the line B0 turns true. The line B0 turns true once the voltage of the section 204B goes into the defined or expected range. The line C1 is the logical NAND 300 of the line A3 and the line B3. That is, the line C1 is false only if both the line A2 and the line S1 are true. The line D1 is the logical NAND 307 of the line K2 and the line S2. That is, the line D1 is false only if both the line K2 and the line S2 are true. The line S1, S2 and S3 are secured-low control lines from the main controller block 301. The line A0, A1, B0, B1 and K2 feedback to the main controller block 301 with the bus states.

The Delay1 312 and 313, and Delay2 306 each comprises an electrical delay circuit which updates its output according to its input after a predefined delay time. In other words, the output A1, B1 and K2 of the Delay1 312 and 313, and Delay2 306 keep their states unchanged when the input A0, B0, and K1 of the Delay1 312 and 313, and Delay2 306, respectively, change their states. After the predefined delays elapse, the output A1, B1, and K2 of the Delay1 312 and 313, and Delay2 306, respectively, change their states according to the changes of the input A0, B0 and K1 of the Delay1 312 and 313, and Delay2 306. For example, the output A1 of Delay1 312 does not turn high instantly when the input A0 of Delay1 312 turns high. Instead, the output A1 of Delay1 312 turns high only after the predefined delay time elapses from when the input A0 of Delay1 312 turns high.

### Second Node Embodiment—Bus with Separate Data and Power

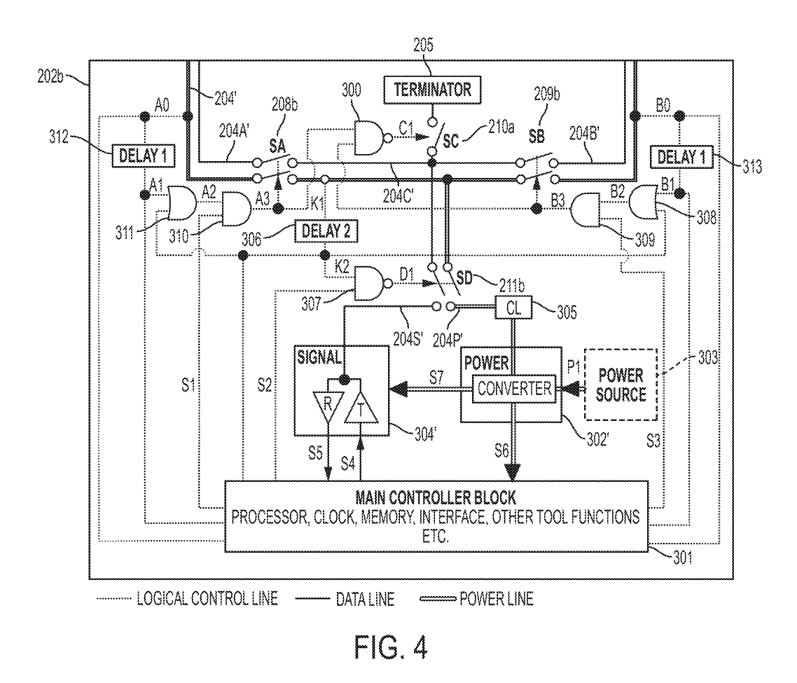

FIG. 4 is a schematic diagram of another example embodiment of one node 202. In the embodiment, the tool bus has the data signal and power signal transmitted separately. In the FIG. 3b, the bus switches SA 208b and SB 209b, the tool switch SD 211b are made up of two-contact switch. One contact is used for the bus data signal and the other is used for the bus power. The control lines A0, B0, and K1 are derived from the bus power to sense the power events. The signal block 304′ is directly connected to the bus signal line 204S′ and the power block 302′ is connected to the bus power line 204P′ through the current limiter CL 305, respectively without any couplers because the data signal and power signal are separated. The rest is similar to the embodiment in FIG. 3.

### Possible Switch Embodiments

The four switches can be any electrically operated device with two discrete states, close and open. In the close state, the switch passes the electrical signal freely with negligible insertion loss. In the open state, the switch blocks the electrical signal from passing through. The switch may be solid-state, such as a thyristor, a BJT, a FET or IGBT. The switch may also be electromechanical, such as a relay.

FET technology has been advancing rapidly in the past decades and is preferred for its performance and reliability in downhole applications. Specifically, a MOSFET switch has a fast switching speed and low drive signal requirements. MOSFET switches suitable for power control, however, are typically unidirectional devices due to their intrinsic body diodes.

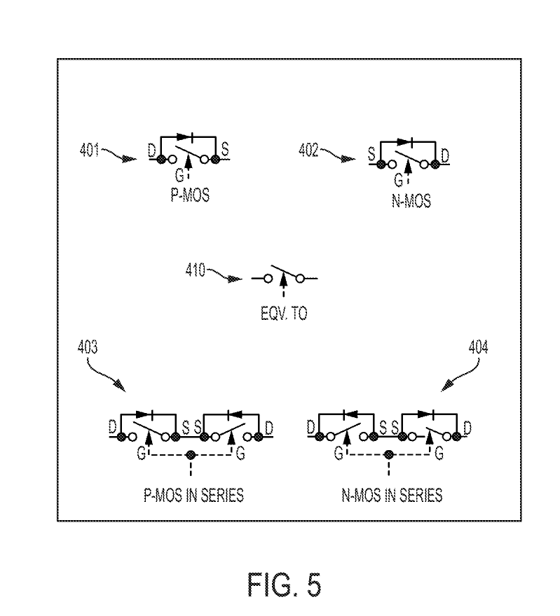

FIG. 5 illustrates schematics of the equivalent circuit models of a P-channel MOSFET 401, an N-channel MOSFET 402. In the open state, either MOSFET blocks the electrical signal in one direction while still allowing the signal to pass through in the other direction (i.e., with the forward voltage drop of the diode as shown). A bidirectional switch 410, as used in the previously described embodiments, can be replaced with two MOSFET switches of the same type placed back-to-back in series. FIG. 5 also shows schematics of the equivalent circuit models for a P-channel MOSFET bidirectional switch 403 (e.g., a head-to-head configuration) and an N-channel MOSFET bidirectional switch 404 (e.g., a back-to-back configuration).

### Third Node Embodiment—Unidirectional Switches

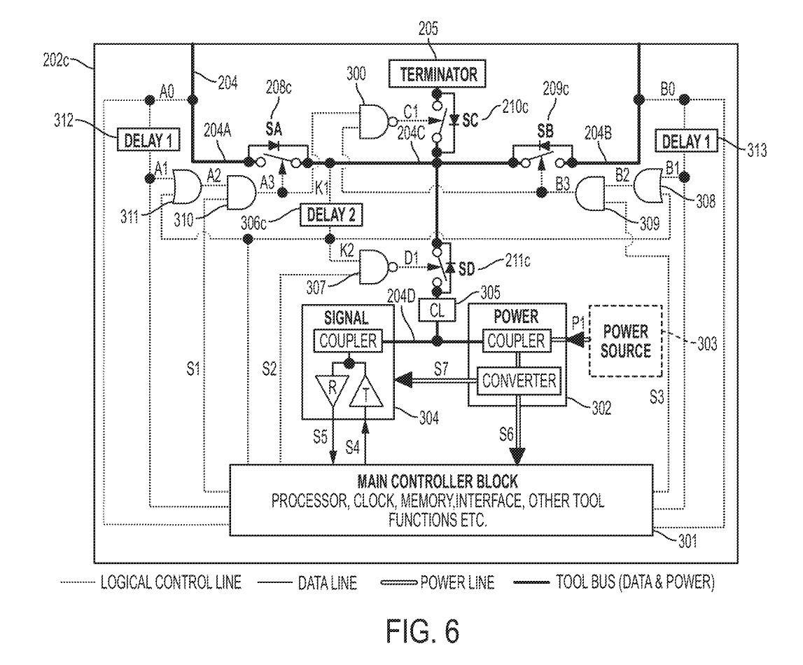

In some applications, the direction of bus current is known and so switching control is only required in one direction. FIG. 6 displays a schematic diagram of another example embodiment of a node 202. In the FIG. 6, the four unidirectional switches (e.g., as shown in FIG. 5) are substituted for the bidirectional switches in the FIG. 3.

The two bus switches SA 208c and SB 209c allow the external bus current to freely through regardless the states of the switches, with negligible difference of one diode forward voltage drop if the switches are open. As a result, the bus section 204C will receive when either section 204A or section 204B receives power, and consequently, the Delay2 306c starts counting at the same time as Delay1 312, 313. The terminator 205 typical sinks electrical current from the bus 204 so that the unidirectional switch 210c functionally has no difference from the bidirectional one. Similarly, the tool switch 211c causes no difference if the tool only sinks electrical current from the bus 204. If the tool only sources electrical current to the bus 204, the polarity of the tool switch 211c can be reversed (i.e., from what is shown in FIG. 6). If the tool sinks and sources electrical current from/to the bus then two unidirectional switches 403, 404, as shown in FIG. 5, can be used. The node embodiment using unidirectional switches, as shown in FIG. 6, is otherwise similar to the embodiment shown in FIG. 3.

### Fourth Node Embodiment—Logic Circuit Equivalents

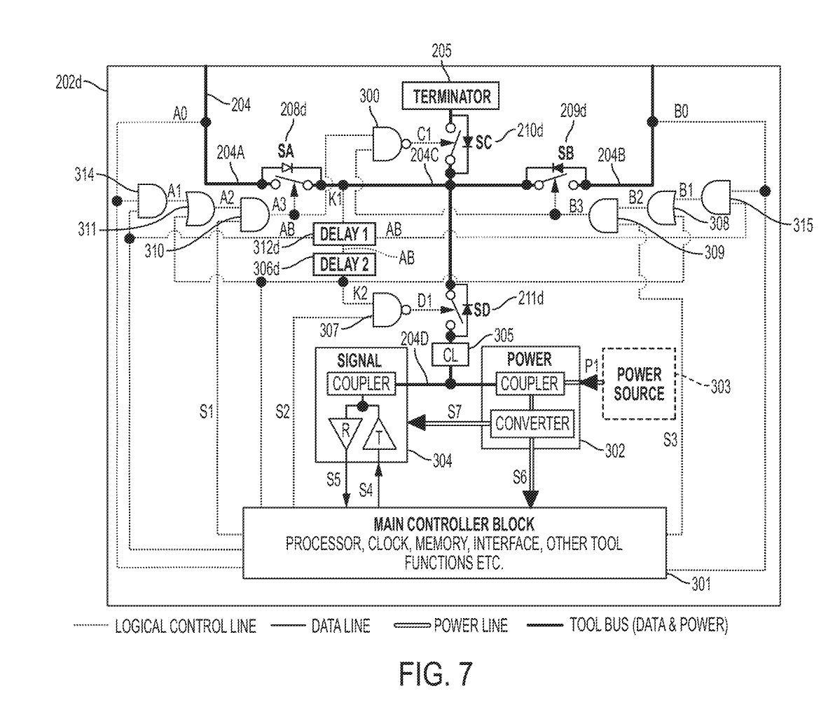

FIG. 7 is a schematic diagram of another example embodiment of a node 202. For the node embodiment shown in FIG. 7, the four unidirectional switches (e.g., MOSFET switches) are used as in the FIG. 6. Given the fact that the bus section 204C will be powered up at the same time as bus sections 204A or 204B, only one Delay1 312d is used. The Delay1 312d changes the logical control line AB into the true state after the specific time delay once the line K1 turns true. The line K1 turns true once the voltage of the section 204C goes into the valid range. The line A1 is the logical AND 314 of the line AB and the line A0. That is, the line A1 is true only if both the line AB and the line A0 are true. The line B1 is the logical AND 315 of the line AB and the line B0. That is, the line B1 is true only if both the line AB and the line B0 are true. The Delay2 306d changes the logical control line K2 into the true state after the specific time delay once the line AB turns true. Logically, line A1 turns true in the Delay1 312d after line A0 turns true, and line B1 turns true in the Delay1 312d after line B0 turns true. The Delay2 306d starts counting when the line AB turns true, or equivalently the Delay1 312d stops. It is clear that the line A1, B1 and K2 have the same logical meaning as those in the FIG. 3. Accordingly, other than the change to the logic, the embodiment shown in FIG. 7 is similar to the embodiment shown in FIG. 3.

In fact, by virtue of the logical equivalence law there are other node embodiments (i.e., with different logic circuits) that can operate as the embodiment presented thus far. An important aspect of the node in all embodiments is the use of controllable switches power various parts (nodes 202 or bus sections 203) of the bus system 204 independently or in sequence so that each portion can be separately diagnosed or particular application needs can be met.

### Intelligent Control of Tool Switches

As shown each node embodiment integrates multiple controllable switches (i.e., SA, SB, SC, and SD). The switches (e.g., typically SA, SB, and SD) are directly controlled by secured control lines, while the switch SC derived its state from the states of both switch SA and SB in the above embodiments. However, the switch SC may also be directly controlled by one secured control lines in other embodiments. A secured control line for a switch has two states, a default state and a secured state, which can be mapped to two logical states of true and false (i.e., the voltage states of high and low). For example, a secured-low control line can have a low voltage as its secured state and a high voltage as its default state. Likewise, a secured-high control line can have a high voltage as its secured state and a low voltage as its default state. A secured state may be issued only when a node is operating properly, while a default state is issued when a node has a fault.

The secured control line signals are issued by the main controller in the main controller block 301. The main controller block 301 may include a main controller, a clock, a memory, various interfaces, as well as other tool functional circuits. The main controller may be a processor, a DSP, a microcontroller, an FPGA, an ASIC, or the like, and runs the tool self-diagnostic test. The main controller adjusts the configuration (i.e., states) of the switches (i.e., turns them ON/OFF) by adjusting the state of secured control lines that control the switches. When the tool experiences a fault, the secured control lines automatically assume their default states. In the default state, (i) the tool switch SD 211 is opened to disconnect the tool from the bus and (ii) the bus switches SA 208 and SB 209 is closed to pass through the bus signal freely. As a result, the tool bus is able to accommodate the tool fault without disrupting the communication on the tool bus network. Additionally, the state of the terminator switch SC 210 is linked (via logic circuits) to the states of the bus switches SA 208 and SB 209. For example, the terminator switch SC 210 automatically opens when both the bus switch SA 208 and SB 209 close prevent repetitive bus terminations (i.e., only terminators of the two distal nodes are connected to the bus). In other words, the terminator switch is closed to connect the terminator to the bus when either bus switch, SA 208 or SB 209, is opened.

The main controller is usually a digital circuit, which only assumes two logical states: high and low. The discrete nature of digital circuit has inherently superior immunity to oscillation unless it is deliberately tuned for it. It is noted, that the main controller usually assumes a relatively stable electrical DC state rather than an oscillating AC despite the fact that the level of the DC state may be low, high, or uncertain in the event of failure or loss of power. By virtue of this fact, an AC signal may be used when the secured state is issued, while an DC signal or lack of the AC signal may be used when the default state is issued.

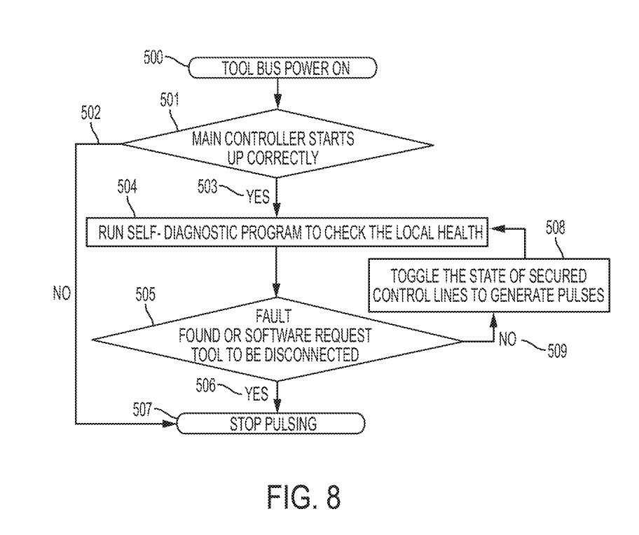

An exemplary process to control a node's switch configuration to adapt to a fault is shown in FIG. 8. In the process, the main controller issues the secured state by generating a AC-like pulse train that is converted by electrical circuit into required secured control outputs (i.e., low or high), and issues the default state by ceasing the pulse train. In lack of the pulse train, the electrical circuit will output the state opposite to the secured state.

Specifically, after tool bus powers on 500, the main controller starts 501. If the main controller starts correctly 503 (i.e., the main controller is properly powered and released from the reset state and its code starts executing without any faults), the main controller runs a self-diagnostic test to check the local health 504 (i.e., function of the tool) to detect one or more faults 505 that require the tool to be disconnected from the bus (e.g. a high current which triggered the local current limiter CL 305, AC short circuit in the signal block 304, dysfunctional core circuits). If the no faults are found 509, then the main controller will toggle (e.g., from high to low, from low to high) an output 508 once. The main controller then repeats the local health check 504.

Accordingly, a pulse train 510 is generated by the main controller until a fault occurs. If a fault is found 506, the main controller stops pulsing. In other words, the pulse train corresponds to the state of the secured control line that controls the tool switch. When the main controller stops transmitting pulses, the secured line changes states, and the tool is disconnected from the bus.

In some cases, a tool may be configured (e.g., by software or command received from the tool bus) to issue a request to the main controller that is related to its connection to the bus. For example, the controller may receive a request to remove the tool from the bus. This request may be treated as the detection of a fault. Accordingly, if a request for a tool to be disconnected is received 505, then the main controller stops transmitting pulses, the secured line changes states, and the tool is disconnected from the bus.

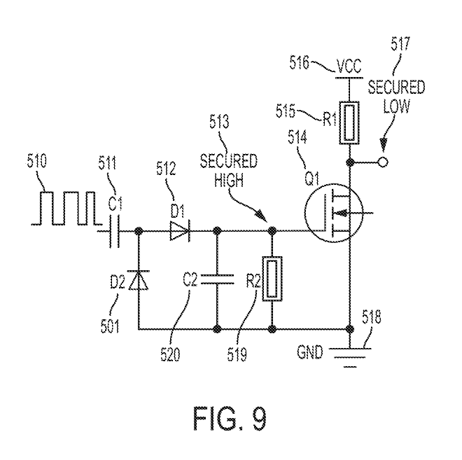

An exemplary circuit for converting the pulse train into a secured control line state (e.g., LOW) is shown in FIG. 9. The AC-coupled rectification circuit has a capacitor C1 511 which is coupled to the output of the main controller. When the pulse train 510 turns high, the diode D1 512 is conducts so that both capacitors C1 511 and C2 520 are charged while the diode D2 521 is reverse biased. When the pulse train 510 turns low, the diode D2 521 conducts so that the capacitor C1 511 can be discharged while the diode D1 512 is reversed bias and prevents the capacitor C2 520 from discharging. When the pulse train 510 alternates its states successively, the capacitor C2 520 is charged continuously and remains at a high voltage.

Additionally, capacitor C1 511 is alternatively charged and discharged, reaching a balanced state. When the pulse train 510 stops, the capacitor C1 511 blocks any DC signal so that the capacitor C2 520 cannot be charged. The resistor R2 519 then rapidly discharges the capacitor C2 520 to the low state. Therefore, a secured-high control signal 513 can be generated which can only be in the high state when a pulse train is available (i.e. while no faults are found).

The N-channel MOSFET Q1 514 in function with the pull-up resistor R1 515 to generates a low control signal 517 when a high signal 513 is applied to the gate. Specifically, when the high signal 513 is applied to the gate of the Q1 514 then Q1 conducts, effectively shorting the output to ground (i.e., LOW) 517. When the pulse train stops and the voltage at the gate drops, then Q1 514 does not conduct and the output 517 floats to high voltage (i.e., high state). The high state is determined by the level of the power source VCC 516, which can be derived from the bus power.

### Exemplary Operation of a Node

As shown in FIG. 9 the secured control line circuit receives a pulse train 510 (i.e., from the main controller) at its input when the tool electronics in the node are operating without fault (i.e., in a secured state). Due to the AC-coupling and rectification of the secured control line circuit, a secured high voltage 513 controls a MOSFET 514, operating as a switch, to close, thereby connecting the output of the circuit 517 to ground 518. The output 517 is a secured-low control signal that serves to control the tool switch 211 through the line S2 and/or the bus switches (208 and/or 209) through the line S1 and S3 in the node 202. In a default state (e.g., no pulse train 510 is being provided), the MOSFET 514 is in an open state, thereby producing a high voltage on the output 517. In a secured state (e.g., a pulse train 510 is being provided), the MOSFET 514 is closed, thereby producing a low voltage on the output 517. In the secured state, the bus switch (208 and/or 209) are opened to disconnect one bus section from the next one, and the tool switch 211 is closed to continuously power the tool 212.

In normal operation without a fault, either a secured state or a default state can be issued. A fault may occur if the main controller block 301 does not start up properly due to a fault in the main controller block 301, or if there is a lack of power due to a fault in the power block 302, or if a fault is detected in the node 202 by the main controller block 301. If a fault occurs, the main controller block 301 does not generate the pulse train 510 and the output of the circuit 517 is a non-zero voltage (i.e., the default high state of a secured-low control line). In the default high state, the bus switch (208 and/or 209) are closed to freely pass the bus signal from one bus section to the next one. Thereby, the integrity of the whole bus channel is assured so that communication among other nodes on the bus 204 can continue.

In the default high state, the tool switch 211 is opened to disconnected the tool 212 from the bus 204 so that the fault does not affect the communication with other nodes. In the event of a tool fault, a default state must be issued and a secured state must not be issued to effectively quarantine the faulted node 202 from the bus 204 and keep other nodes unaffected.

There is one exception to the rules when a node 202 is first powered up. Further details regarding the operation of a node during power-up are provided as follows. The Delay1 (312 or 313) and the Delay2 306 create a delayed response to their respective inputs. Special operating rules are followed during this duration from when one bus section connected to one node 202 is powered up to when the Delay2 306 of the node 202 elapses. The embodiment of node 202 in FIG. 3 is used to illustrate the special rules during power-up of the node 202, though the same rules may apply to the other embodiments as well. Also, in the below explanation, it is further assumed that the left bus section 204A is first powered up. However, it should be understood that this assumption does not imply any limitations, and the principles and methods disclosed herein apply to other embodiments or power-up scenarios.

Once the bus section 204A is powered up, the line A0 turns high and the Delay1 312 starts counting. Only the line A0 is in high state while other control lines are in low state before the Delay1 312 elapses. The bus switch SA 208a is opened so that only the left bus section 204A is powered. During this period, the left bus section 204A can be tested for any faults, i.e., current leakage or short circuit.

Once the Delay1 312 elapses but before the Delay2 306 elapses, the line A1 turns high. In turn, the line A2 turns high since it is the logical OR 311 of the line A1 in high and the line K2 in low. The secured-low line S1 is in default high state given that main controller block 301 is not powered up. Hence, the line A3 turns high as it is the logical AND 310 of the line A2 which is high and the line A3 which is high due to the default high state. The bus switch SA 208a is closed and the bus section 204C is also powered up. The line C1 turns high as it is the logical NAND 300 of the line A3 which is high and the line B3 which is low. Accordingly, the terminator switch SC 210a is closed to connected the terminator 205 to the bus 204.

Thereafter, bus communication to the node 202 may start as the bus 204 is properly terminated. The line K2 is still low as the Delay2 306 has not yet elapse. The line D1 turns high as it is the logical NAND 307 of the line K2 which is low and the line S2 which is in the default high state. Therefore, the tool switch SD 211a is closed to power the tool 212 (i.e., the node backend electronics) including the main controller block 301 and other circuits. Then the tool 212 can be tested through a self-diagnostic program running in the main control block 301.

Although the line S3 is in the default high state, the line B3 remains low as the line B2, K2, B1 and B0 are all low. The bus switch SB 209a remains open and the right bus section 204B is not powered. The powered node 202 can be tested for any faults, e.g., open circuit, short circuit or erratic response independently. In case of short circuit, the current limiter CL 305 can limit the input current drawn from the bus so that the bus 204 is not disabled by the fault. If the node is tested good, it may issue the secured state (i.e. a secured-low state) on the secured-low line S2 to lock the tool switch SD 211a in closed position even if the line K2 turns high after the Delay2 elapses. The node 202 can then be continuously powered by the bus 204.

Delay2 306 is longer than Delay1 312, 313. The duration between the Delay1 312 and Delay2 306, creates a lockable time window, in which only a good node 202 (e.g., a node that does not have any faults) can attach itself to the bus 202 for the following communication. If the node 202 has any faults, the secured-state (i.e. the secured-low state) will not be issued on the line S2. The node 202 with any faults will automatically detach from the bus 202 after the Delay2 306 elapses. Specifically, after the Delay2 306, the line D1 turns low as it is the logical NAND 307 of the line K2 which is high and S2 which is in the default high state. In other words, the tool switch SD 211a is locked open or closed as described above based on whether the secured state is issued on the secured-low line S2 within the lockable time window.

After Delay2 306 elapses, the line B2 turns high as it is the logical OR 308 of the line K2 which is now high and the line B1 which is low. The line B3 turns high as it is the logical AND 309 of the line B2 which is now high and the line S3 which is in the default high state. Accordingly, the bus switch SB 209a turns on to power on the right section 204B regardless of whether the node 202 has any faults. Because the line B3 and the line A3 are both now high, the line C1 turns low as it is the logical NAND 300 of the line A3 and the line B3. Therefore, the terminator switch SC 210a is opened. The same sequence can continue until the whole bus 204 is powered up with all problematic nodes automatically detaching from the bus 202. Additionally, the bus 204 automatically terminates at the distal ends of the bus 204.

In the embodiments which use unidirectional switches as in the FIGS. 6 and 7. It is slightly different that the left bus section 204A and the middle bus section 204C is powered up simultaneously so that the left bus section 204A and the node front-end electronics are powered before the tool switch 211 and have to be tested together. Given the simplicity of the node frontend electronics, they can be implemented in a most robust manner so that little effect is caused on the bus performance.

It should be understood that there are varied embodiments to achieve a fault-tolerant secured control line. For instance, in FIG. 9, the capacitor C1 511 can be replaced with a transformer to achieve AC coupling, the MOSFET Q1 514 can be replaced with an NPN transistor or other suitable switches or relays. In some instances, an integrated circuit like a watchdog IC may be used. In any event, secured control lines should remain in their default state to achieve a defined circuit response in case of faults.

Although the disclosed embodiments in FIG. 3, FIG. 4, FIG. 6 and FIG. 7, four switches are used to achieve a universal applicability to all applications, one or two of the four switches might be spared in the specific circumstances without significant loss of the disclosed benefits and without departing from the principles and methods disclosed herein.

In some low-speed or short tool bus systems, signal reflection without bus terminations might be insignificant, the bus terminator switch might not be used or be replaced by manually-set terminators.

In some tool bus systems, the direction of bus current is fixed and does not change in the operation. If the unidirectional switch is used as in the FIG. 6 and FIG. 7, the bus switch that has its body diode forward in the current direction might be spared. For example, if the bus current comes from the left bus section 204A in the FIG. 6, the bus switch 208c is dispensable as the its body diode always passes the bus signal.

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

1. A tool bus network for a bottom hole assembly (BHA), the tool bus network comprising:
a bus comprised of bus sections that are connected at nodes, wherein a node comprises:
a first bus switch configurable based on a first secured control line to connect a first bus section to a second bus section so that when the bus switch is closed data and/or power is able to pass between the first and second bus sections, wherein a default state of the first secured control line configures the bus switch to be closed;
a tool switch configurable based on a second secured control line to connect node backend electronics including a main controller and tool electronics within the node on a first side of the tool switch to the second bus section on a second side of the tool switch opposite from the first side of the tool switch when the tool switch is closed, wherein a default state of the second secured control line configures the tool switch to be open; and
the main controller connected to the tool switch, wherein the main controller is configured to adjust a configuration of the first bus switch by adjusting a state of the first secured control line, and the main controller is configured to adjust a configuration of the tool switch by adjusting a state of the second secure control line, wherein the first secured control line and the second secured control line automatically assume the default state of the first secured control line and the default state of the second secured control line upon a fault or power loss in the main controller.

2. The network according to claim 1, wherein at least one of the nodes communicatively couples the network to equipment at a surface of a wellbore using telemetry.

3. The tool bus network according to claim 1, wherein the first and second bus sections comprises separate electrical channels for the data and power.

4. The tool bus network according to claim 1, wherein either or both the bus switch or the tool switch comprises a unidirectional switch, a combination of two unidirectional switches in a back-to-back or head-to-head configuration, or a bidirectional switch.

5. The tool bus network according to claim 1, wherein the main controller of the tool electronics is configured to adjust a configuration of the tool switch by adjusting a state of the second secure control line to a secured state to close the tool switch to connect the tool electronics to the second bus section.

6. The tool bus network according to claim 1, wherein the main controller of the tool electronics is configured to adjust a configuration of the bus switch by adjusting a state of the first secure control line to a secured state to open the bus switch to disconnect the first bus section from the second bus section.

7. The tool bus network according to claim 5, wherein the first or second secured control line comprises an AC-coupled rectification circuit configured to issue the secured state in response to receiving a pulse train from the main controller and otherwise issue the default state.

8. The tool bus network according to claim 7, wherein the main controller is configured to run a self-diagnostic test to test for a fault in the tool electronics, wherein the main controller is configured to provide the pulse train to the AC-coupled rectification circuit when the fault in the tool electronics is not detected.

9. The tool bus network according to claim 1, wherein the node further comprises a terminator switch configurable to connect a terminator to the second bus section when the terminator switch is closed, wherein the terminator switch is configurable based on the bus switch.

10. The tool bus network according to claim 9, wherein the terminator switch is open when the bus switch is closed.

11. The tool bus network according to claim 9, wherein the terminator has an impedance that is the same as the characteristic impedance of the second bus section.

12. The tool bus network according to claim 1, wherein the node further comprises a second bus switch configurable based on a third secured control line to connect the second bus section to a third bus section so that when both the first bus switch and the second bus switch are closed, data and/or power is able to pass between the first, second, and third bus sections.

13. The tool bus network according to claim 1, wherein the node further comprises a first delay circuit with an input connected to the second bus section and configured to change an output of the first delay circuit after a first defined delay according to a change in a voltage level on the second bus section.

14. The tool bus network according to claim 13, wherein the node further comprises a second delay circuit and configured to change an output of the second delay circuit after a second defined delay according to a change in an input of the second delay circuit.

15. The tool bus network according to claim 14, wherein an input of the second delay circuit is connected to the second bus section, wherein the second defined delay is longer than the first defined delay to create a window to control the tool switch to disconnect the tool electronics from the second bus section when the fault is detected.

16. The tool bus network according to claim 14, an input of the second delay circuit is connected to an output of the first delay circuit to create a window between the first delay and the second delay to control the tool switch to disconnect the tool electronics from the second bus section when the fault is detected.

17. The tool bus network according to claim 14, wherein the first bus switch is configured to close after the second defined delay when the fault is detected in the tool electronics.

18. The tool bus network according to claim 1, wherein the node further comprises a current limiter in series with the tool switch configured to limit an amount of current which can pass to the tool electronics.

19. The tool bus network according to claim 7, wherein the AC-coupled rectification circuit is configured to pass an AC component of the pulse train to a rectification circuit to generate a voltage level corresponding to a secured-high state, and
wherein the AC-coupled rectification circuit is further configured to block DC signals from being passed to the rectification circuit to generate the default state.

20. The tool bus network according to claim 19, wherein the first or second secured control line further comprises a voltage inversion circuit connected to an output of the rectification circuit, wherein the inversion circuit is configured to generate a voltage level corresponding a secured-low state upon receiving the voltage level corresponding to the secured-high state.
